(19) United States
(12) Patent Application Publication
(10) Pub. No.: US 2019/0244238 A1
(43) Pub. Date: Aug. 8, 2019

(54) METHOD FOR DISTRIBUTING REWARD VALUE AND MEMBER COMPUTER DEVICE

(71) Applicant: RE CO LTD., Taipei City (TW)

(72) Inventors: Yi-Chung LIN, Taipei City (TW); Chih-Feng HUANG, Taipei City (TW); Yung-Hsiang CHANG, Taipei City (TW)

(21) Appl. No.: 16/129,073

(22) Filed: Sep. 12, 2018

(30) Foreign Application Priority Data
Feb. 5, 2018 (TW) 107104045

(51) Int. Cl. G06Q 30/02

(52) U.S. Cl. CPC G06Q 30/0229; G06Q 30/0215; G06Q 30/0236; G06Q 30/0233

(57) ABSTRACT

A method for distributing a reward value includes the following steps of: getting a consumption amount spent in a second store by a member of a first store; calculating a reward value by multiplicating a preset ratio with the consumption amount; randomly distributing the reward value into at least two parts of the reward value; and transmitting one of the parts of the reward value to an account of the member. A member computer device applied to the method is also disclosed.

### CROSS REFERENCE TO RELATED APPLICATIONS

This Non-provisional application claims priority under 35 U.S.C. § 119(a) on Patent Application No(s). 107104045 filed in Taiwan, Republic of China on Feb. 5, 2018, the entire contents of which are hereby incorporated by reference.

### BACKGROUND

### Technology Field

This disclosure relates to a method for distributing a reward value and a member computer device that can randomly distribute a reward value.

### Description of Related Art

In order to stimulate consumption, stores often offer discounts to consumers or give discount coupons to the consumers, thereby increasing consumers' willingness to consume again and providing incentives for repurchasing to increase store income. However, the feedback generated by this marketing method is mainly for the consumers. Although the stores increase the income as the consumers purchase in the stores, there is no extra income for the stores.

In recent years, alliance-based consumer feedback platforms (e.g., google pay) have also provided one-directional feedback services from stores to consumers. In other words, the consumers can obtain some feedbacks from stores. In this case, since the stores need to pay the reward money back to the consumers or the service platform, the stores cannot receive timely the corresponding feedback income.

Therefore, it is desired to provide a trade reward method, and the server and store computer device applied to execute the trade reward method that can integrate the trade reward of stores, so that the customer (member) of one store can also receive a certain ratio of trade reward when purchasing in other stores. Thus, the stores or the customer and the store can share the trade rewards, thereby providing the extra rewards for the stores.

In addition, the customers usually passively receive the rewards in a fixed ratio. Since most customers naturally seek for cheaper prices and more discounts, the above-mentioned reward in a fixed ratio may not provide a sufficient incentive for the customers to shop again. This business mechanism may also reduce the fun in shopping.

Therefore, it is desired to provide a method and system for distributing the reward value, and the computer devices of the system that can integrate the trade reward of stores, so that the customer (member) of one store can also receive a certain ratio of trade reward when purchasing in other stores. Besides, the customers can select a favorite reward value from the provided reward lists by themselves. Thus, the stores or the customer and the store can share the trade rewards, thereby providing the extra rewards for the stores.

### SUMMARY

In view of the foregoing, an objective of this disclosure is to provide a method for distributing a reward value and a member computer device for executing the method. Compared with the conventional arts, the method for distributing a reward value and a member computer device of this disclosure can randomly distribute a reward value. Accordingly, when the customer (member) of one store purchases in other stores, the store can receive a trade reward (extra bonus) according to the method for distributing the reward value, and the member can also receive a certain ratio of trade reward by selecting a favorite reward value based on the purchasing motion. This business mechanism can provide an incentive for the member to shop in different stores, and increase the fun in shopping.

To achieve the above objective, the present disclosure provides a method for distributing a reward value, comprising steps of: getting a consumption amount spent in a second store by a member of a first store; calculating a reward value by multiplicating a preset ratio with the consumption amount; randomly distributing the reward value into at least two parts of the reward value; and transmitting one of the parts of the reward value to an account of the member.

In one embodiment, the part of the reward value transmitted to the account of the member is selected by the member from the distributed parts of the reward value.

In one embodiment, the part of the reward value transmitted to the account of the member is selected by the second store from the distributed parts of the reward value.

In one embodiment, the distributed parts of the reward value comprises a first part and a second part, the first part is calculated by multiplicating a first reward ratio with the reward value, and the second part is calculated by multiplicating a second reward ratio with the reward value.

In one embodiment, the distributed parts of the reward value comprises a first part, a second part and a third part, the first part is calculated by multiplicating a first reward ratio with the reward value, the second part is calculated by multiplicating a second reward ratio with the reward value, and the third part is calculated by multiplicating a third reward ratio with the reward value.

In one embodiment, the method for distributing a reward value further comprises a step of: transmitting the part of the reward value, which is not selected, to an account of the first store.

In one embodiment, the preset ratio is between 1% and 50%.

In one embodiment, the first reward ratio, the second reward ratio or the second reward ratio is between 10% and 50%.

In one embodiment, the reward value is calculated by a server.

In one embodiment, the reward value is randomly distributed into the at least two parts of the reward value by the server.

In one embodiment, the reward value is randomly distributed into the at least two parts of the reward value by a store computer device.

In one embodiment, the reward value is calculated by a store computer device.

In one embodiment, the reward value is randomly distributed into the at least two parts of the reward value by the store computer device.

In one embodiment, the reward value is randomly distributed into the at least two parts of the reward value by a server.

In one embodiment, the account is an electronic account.

In addition, the disclosure also provides a system for distributing a reward value comprising a store computer device, a server and a member computer device. The server is communicatively connected with the store computer device. The server or the store computer device gets a consumption amount, calculates a reward value by multiplicating a preset ratio with the consumption amount, and randomly distributes the reward value into at least two parts of the reward value. The consumption amount is spent in a second store by a member of a first store. The member computer device is communicatively connected with the server and the store computer device. The member computer device or the store computer device receives the parts of the reward value, and transmits one of the parts of the reward value to an account of the member.

In one embodiment, the member computer device selects one of the parts of the reward value according to a selection instruction and transmits the selected part to the account of the member.

In one embodiment, the store computer device selects one of the parts of the reward value according to a selection instruction and transmits the selected part to the account of the member.

The present disclosure also provides a member computer device applied to a system for distributing a reward value. The system for distributing the reward value comprises the member computer device, a store computer device and a server. The member computer device and the store computer device are communicatively connected with the server. The member computer device comprises a memory unit and a processing unit. The processing unit is coupled with the memory unit. The memory unit stores a plurality of instructions, and the processing unit executes the instruction to perform the above-mentioned method for distributing the reward value.

In addition, the present disclosure further provides a method for distributing a reward value feeding back a first store or a member of the first store. The method comprises steps of: receiving a reward value from a sponsor; randomly distributing the reward value into at least two parts of the reward value; and transmitting one of the parts of the reward value to an account of the member.

In one embodiment, the sponsor is a physical store or a virtual store.

In one embodiment, the physical store or the virtual store is a second store, and the reward value is calculated by multiplicating a preset ratio with a consumption amount, which is spent in the second store by the member of the first store.

In one embodiment, the sponsor is an advertiser, a non-profit organization or an individual.

In one embodiment, the part of the reward value transmitted to the account of the member is selected by the member from the distributed parts of the reward value.

In one embodiment, the part of the reward value transmitted to the account of the member is selected by the second store from the distributed parts of the reward value.

In one embodiment, the distributed parts of the reward value comprises a first part and a second part, the first part is calculated by multiplicating a first reward ratio with the reward value, and the second part is calculated by multiplicating a second reward ratio with the reward value.

In one embodiment, the distributed parts of the reward value comprises a first part, a second part and a third part, the first part is calculated by multiplicating a first reward ratio with the reward value, the second part is calculated by multiplicating a second reward ratio with the reward value, and the third part is calculated by multiplicating a third reward ratio with the reward value.

In one embodiment, the method for distributing a reward value further comprises a step of: transmitting the part of the reward value, which is not selected, to an account of the first store.

In one embodiment, the preset ratio is between 1% and 50%.

In one embodiment, the first reward ratio, the second reward ratio or the second reward ratio is between 10% and 50%.

In one embodiment, the account is an electronic account.

As mentioned above, the method and system for distributing a reward value and the computer device of the system for executing the method of this disclosure can randomly distribute the reward value. Accordingly, when the customer (member) of one store purchases in other stores, the store can receive a trade reward (extra bonus) according to the method for distributing the reward value, and the member can also receive a certain ratio of trade reward by selecting a favorite reward value based on the purchasing motion. This business mechanism can provide an incentive for the member to shop in different stores, and increase the fun in shopping. Moreover, the stores will be encouraged to actively recruit members for obtaining the trade reward so as to increase their extra incomes. Accordingly, the method and system for distributing the reward value and the computer device of the system for performing the method of this disclosure can provide the trade reward to the stores for increasing the extra incomes of stores, encourage the store to recruit new members, and provide the customers to select the part of the reward value, which can provide the incentive and fun to increase the purchasing of the customers. Therefore, the trade rewards can be shared between the customer and store or between the stores.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a flow chart of a method for distributing a reward value according to an embodiment of the disclosure;

FIG. 2 is a schematic diagram showing the method for distributing a reward value according to the embodiment of the disclosure;

FIG. 3 is a schematic diagram showing a system for distributing a reward value according to the embodiment of the disclosure;

FIG. 4 is another schematic diagram showing the system for distributing a reward value according to the embodiment of the disclosure; and

FIG. 5 is a flow chart of another method for distributing a reward value according to an embodiment of the disclosure.

### DETAILED DESCRIPTION OF THE DISCLOSURE

The present disclosure will be apparent from the following detailed description, which proceeds with reference to the accompanying drawings, wherein the same references relate to the same elements.

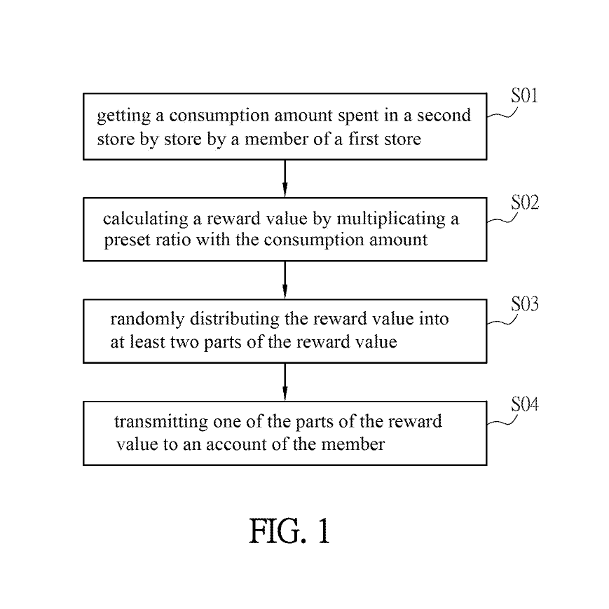

FIG. 1 is a flow chart of a method for distributing a reward value according to an embodiment of the disclosure. As shown in FIG. 1, the method for distributing a reward value comprises the following steps of: getting a consumption amount spent in a second store by a member of a first store (step S01); calculating a reward value by multiplicating a preset ratio with the consumption amount (step S02); randomly distributing the reward value into at least two parts of the reward value (step S03); and transmitting one of the parts of the reward value to an account of the member (step SO4).

In the step S01 of this embodiment, the second store gets a consumption amount spent in a second store by a member of a first store. For example, when a member of the first store purchases in the second store, the second store can receive the consumption amount based on the purchasing motion.

In this embodiment, the first store or the second store is, for example but not limited to, a physical store, a virtual store or an individual. Herein, the terms “first” and “second” are for illustrations only and are not to limit this disclosure.

In this embodiment, the member can be a regular member, a VIP member, a network member, a fan club member, or a consumer who has scanned a store's QR code. For example, when a consumer operates any electronic device to scan the QR code provided by a store, the consumer can be considered as a member of the store. In the present disclosure, it is merely used to exemplify that the customer is a member of the first store, and the type of the member does not constitute a limitation of the present disclosure.

In this embodiment, the reward value can be any form of feedback such as feedback money, feedback points, feedback credits, or cashes, and this disclosure is not limited.

In this embodiment, the reward value is calculated by a server or a store computer device. For example, the store computer device is a terminal device installed in the second store. In the step S01, after receiving the consumption amount, the store computer device of the second store can transmit the consumption amount to the server. Afterwards, the server can perform the step S02 to calculate a reward value by multiplicating a preset ratio with the consumption amount. Alternatively, after receiving the consumption amount, the store computer device of the second store can perform the step S02 to calculate a reward value by multiplicating a preset ratio with the consumption amount.

In this embodiment, the reward value can be randomly distributed by the server or the store computer device. For example, in the step S03, the reward value is transmitted to the server for randomly distributing the reward value into at least two parts of the reward value. Alternatively, in the step S03, the reward value is transmitted to the store computer device of the second store for randomly distributing the reward value into at least two parts of the reward value.

In the step S04 of this embodiment, one of the at least two parts of the reward value is transferred to an account of the member by the server or the store computer device.

In this embodiment, the part transmitted to the account of the member can be selected from the distributed parts of the reward value by the member or the second store. For example, the member or the second store can select one of the at least two parts of the reward value, and then the selected part can be transmitted to the account of the member.

In this embodiment, the distributed parts of the reward value comprises a first part and a second part. The first part is calculated by multiplicating a first reward ratio with the reward value, and the second part is calculated by multiplicating a second reward ratio with the reward value.

In this embodiment, the distributed parts of the reward value comprises a first part, a second part and a third part. The first part is calculated by multiplicating a first reward ratio with the reward value, the second part is calculated by multiplicating a second reward ratio with the reward value, and the third part is calculated by multiplicating a third reward ratio with the reward value. In particular, the distributed parts of the reward value may further comprise a fourth part and a fifth part, and this disclosure is not limited thereto.

In this embodiment, the method for distributing a reward value further comprises a step of: transmitting the part of the reward value, which is not selected, to an account of the first store. For example, when the distributed parts of the reward value comprises a first part, a second part and a third part, and the member or the second store selects one of the first part, the second part and the third part, one of the residual unselected parts can be transmitted to an account of the first store.

In this embodiment, the preset ratio is between 1% and 50%. Preferably, the preset ratio is between 3% and 40%. Preferably, the preset ratio is between 5% and 30%. Preferably, the preset ratio is between 7% and 15%. More preferably, the preset ratio is 10%.

In this embodiment, each of the first reward ratio, the second reward ratio and the third reward ratio is between 10% and 50%. Preferably, each of the first reward ratio, the second reward ratio and the third reward ratio is between 20% and 45%. More preferably, each of the first reward ratio, the second reward ratio and the third reward ratio is between 30% and 40%.

In this embodiment, the first reward ratio, the second reward ratio and the third reward ratio can be the same or different, and this disclosure is not limited.

In this embodiment, the account of the first store or the account of the member can be an electronic account, which can be, for example but not limited to, an e-bank account or an account of an electronic payment platform.

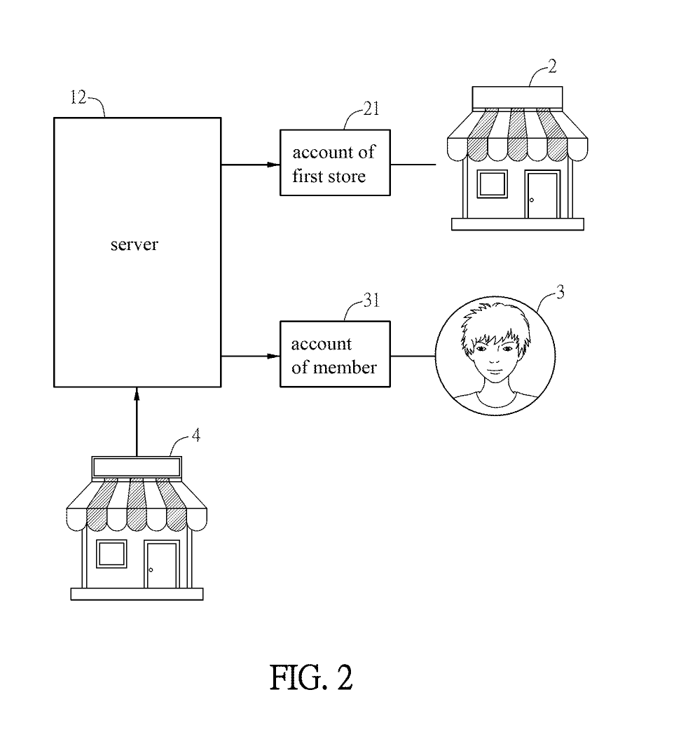

FIG. 2 is a schematic diagram showing the method for distributing a reward value according to the embodiment of the disclosure. As shown in FIG. 2, the second store 4 can transmit a consumption amount, which is spent in the second store 4 by a member 3 of a first store 2, to a server 12. Next, the server 2 calculates a reward value by multiplicating a preset ratio with the consumption amount, and randomly distributes the reward value into at least two parts of the reward value. Afterwards, the server 2 transmits one of the parts of the reward value to an account 31 of the member 3. Preferably, the server 12 can further transmit one of the parts of the reward value, which are not selected, to an account 21 of the first store 2. The arrows indicate the transmitting directions of the consumption amount, the reward value or the parts of the reward value.

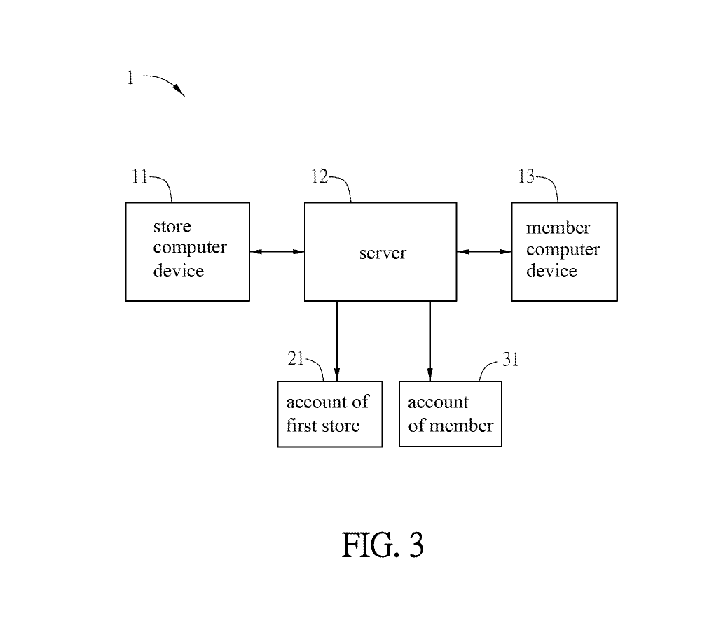

FIG. 3 is a schematic diagram showing a system 1 for distributing a reward value according to the embodiment of the disclosure. The system 1 comprises a store computer device 11, a server 12 and a member computer device 13. The member computer device 13 is communicatively connected with the server 12 and the store computer device 11. The communicative connection thereof can be, for example but not limited to, a network connection.

In this embodiment, the server 12 or the store computer device 11 gets a consumption amount, calculates a reward value by multiplicating a preset ratio with the consumption amount, and randomly distributes the reward value into at least two parts of the reward value. The consumption amount is spent in a second store by a member of a first store. The member computer device 13 or the store computer device 11 receives the parts of the reward value, and transmits one of the parts of the reward value to an account 31 of the member.

In the embodiment, the member computer device 13 or the store computer device 11 selects one of the parts of the reward value according to a selection instruction and transmits the selected part to the account 31 of the member. For example, the member can click the member computer device 13 to select the part of the reward value, and then the selected part can be transmitted to the account 31 of the member. Preferably, one of the unselected parts of the reward value can be transmitted to the account 21 of the first store.

For example, as shown in FIG. 3, the server 12 or the store computer device 11 gets a consumption amount, calculates a reward value by multiplicating a preset ratio with the consumption amount, and randomly distributes the reward value into at least two parts of the reward value. Then, the selected part of the reward value can be transmitted to the account 31 of the member, and one of the unselected parts of the reward value can be transmitted to the account 21 of the first store. The arrows indicate the transmitting directions of the consumption amount, the reward value or the parts of the reward value.

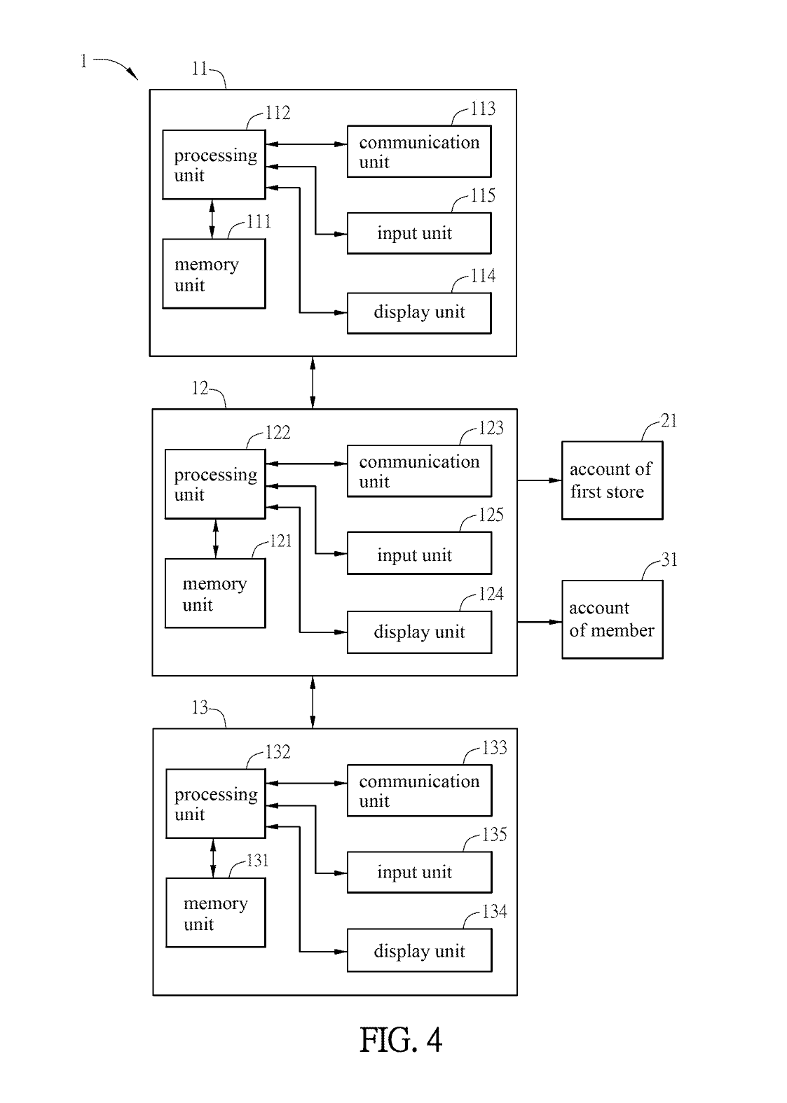

FIG. 4 is another schematic diagram of the system 1 according to the embodiment of the disclosure. Referring to FIG. 4, the store computer device 11 comprises a memory unit 111, a processing unit 112, a communication unit 113, a display unit 114, an input unit 115 and a housing (not shown). The memory unit 111, the processing unit 112 and the communication unit 113 are disposed inside the housing of the store computer device 11.

The processing unit 112 is coupled with the memory unit 111, the communication unit 113, the display unit 114, and the input unit 115, and is configured for executing instructions (e.g. program codes) to perform the above-mentioned method for distributing a reward value. The processing unit 112 is, for example, a processor for executing the instructions (e.g. program codes). The store computer device 11 may include one or more processors, and the processor can be a single-core or multi-core processor. The memory unit 111 can be any storage medium such as a random access memory or a non-volatile computer readable storage medium (e.g., a hard disk, a solid state disk (SSD), a flash memory, etc.). The memory unit 111 stores the instructions (e.g. program codes) that can be executed by the processing unit 112. In practice, the instructions (e.g. program codes) can be loaded from the non-volatile computer readable storage medium to the random access memory, and then the processing unit 112 can execute the loaded instructions. The communication unit 113 can be, for example, a network card, a network chip, a modem, or the likes that can provide a network connection. The display unit 114 includes a display card, a display chip, a display device, or the likes. The input unit 115 can be, for example, a keyboard, a mouse, or a touch screen, etc.

Referring to FIG. 4, the server 12 comprises a memory unit 121, a processing unit 122, a communication unit 123, a display unit 124, an input unit 125 and a housing (not shown). The memory unit 121, the processing unit 122 and the communication unit 123 are disposed inside the housing of the server 12.

The processing unit 122 is coupled with the memory unit 121, the communication unit 123, the display unit 124, and the input unit 125, and is configured for executing instructions (e.g. program codes) to perform the above-mentioned method for distributing a reward value. The processing unit 122 is, for example, a processor for executing the instructions (e.g. program codes). The server 12 may include one or more processors, and the processor can be a single-core or multi-core processor. The memory unit 121 can be any storage medium such as a random access memory or a non-volatile computer readable storage medium (e.g., a hard disk, a solid state disk (SSD), a flash memory, etc.). The memory unit 121 stores the instructions (e.g. program codes) that can be executed by the processing unit 122. In practice, the instructions (e.g. program codes) can be loaded from the non-volatile computer readable storage medium to the random access memory, and then the processing unit 122 can execute the loaded instructions. The communication unit 123 can be, for example, a network card, a network chip, a modem, or the likes that can provide a network connection. The display unit 124 includes a display card, a display chip, a display device, or the likes. The input unit 125 can be, for example, a keyboard, a mouse, or a touch screen, etc.

Referring to FIG. 4, the member computer device 13 comprises a memory unit 131, a processing unit 132, a communication unit 133, a display unit 134, an input unit 135 and a housing (not shown). The memory unit 131, the processing unit 132 and the communication unit 133 are disposed inside the housing of the member computer device 13.

The processing unit 132 is coupled with the memory unit 131, the communication unit 133, the display unit 134, and the input unit 135, and is configured for executing instructions (e.g. program codes) to perform the above-mentioned method for distributing a reward value. The processing unit 132 is, for example, a processor for executing the instructions (e.g. program codes). The member computer device 13 may include one or more processors, and the processor can be a single-core or multi-core processor. The memory unit 131 can be any storage medium such as a random access memory or a non-volatile computer readable storage medium (e.g., a hard disk, a solid state disk (SSD), a flash memory, etc.). The memory unit 131 stores the instructions (e.g. program codes) that can be executed by the processing unit 132. In practice, the instructions (e.g. program codes) can be loaded from the non-volatile computer readable storage medium to the random access memory, and then the processing unit 132 can execute the loaded instructions. The communication unit 133 can be, for example, a network card, a network chip, a modem, or the likes that can provide a network connection. The display unit 134 includes a display card, a display chip, a display device, or the likes. The input unit 135 can be, for example, a keyboard, a mouse, or a touch screen, etc.

In this embodiment, the store computer device 11 of FIG. 4 can be, for example, a mobile device, a notebook computer, a desktop computer, a network device (e.g. smart appliance or smart watch), or other computer devices. Each of the mobile device, notebook computer, desktop computer, and network device includes a housing for accommodating the memory unit 111, the processing unit 112 and the communication unit 113. In the mobile device and notebook computer, the display unit 114 and the input unit 115 are installed on the housing. In the desktop computer, the display unit 114 and the input unit 115 are individual devices connected to the computer host. In the network device, the display unit 114 and the input unit 115 can be installed on the housing or individual devices connected to the host.

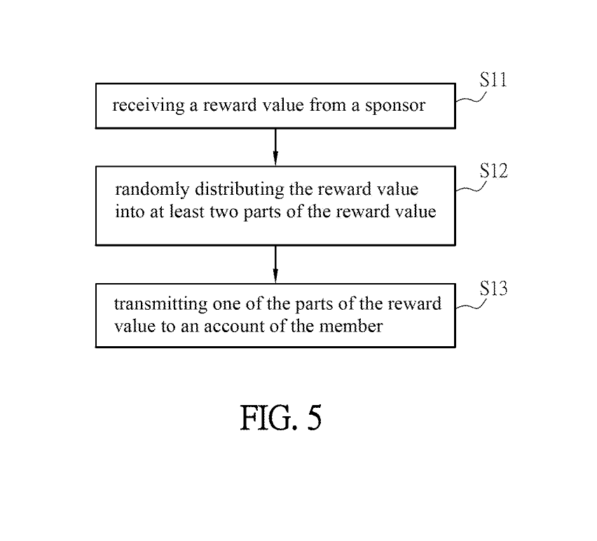

FIG. 5 is a flow chart of another method for distributing a reward value according to an embodiment of the disclosure. As shown in FIG. 5, the method for distributing a reward value comprises the following steps of: receiving a reward value from a sponsor (step S11); randomly distributing the reward value into at least two parts of the reward value (step S12); and transmitting one of the parts of the reward value to an account of the member (step S13).

In the step S11 of this embodiment, the server or the store computer device can receive a reward value from a sponsor, and this disclosure is not limited thereto.

In the step S12 of this embodiment, the server or the store computer device can randomly distributing the reward value into at least two parts of the reward value, and the disclosure is not limited thereto.

In the step S13 of this embodiment, the server can transmit one of the parts of the reward value to an account of the member. For example, the part of the reward value can be transmitted through the wired network or wireless network.

In the embodiment, the sponsor can be a physical store or a virtual store. For example, the physical store can be a physical consumption place such as a restaurant, a cafe, a supermarket, a mass merchandise store, a department store, an entertainment place, etc. The present disclosure is not limited thereto. The virtual store can be a virtual consumption place such as an online store, an online auction store, etc. The present disclosure is not limited thereto.

In this embodiment, the physical store or virtual store is defined as a second store, and the reward value is calculated by multiplicating a preset ratio with a consumption amount, which is spent in the second store by a member of the first store.

In this embodiment, the preset ratio is between 1% and 50%. Preferably, the preset ratio is between 3% and 40%. Preferably, the preset ratio is between 5% and 30%. Preferably, the preset ratio is between 7% and 15%. More preferably, the preset ratio is 10%.

In this embodiment, the sponsor can be an advertiser, a non-profit organization or an individual. For example, the sponsor can be a charity, an agent company, an advertising company, a government agency or an individual that wants to provide the reward value, and this disclosure is not limited thereto.

In this embodiment, the part of the reward value transmitted to the account of the member is selected by the member or the second store from the distributed parts of the reward value. For example, the member 3 or the second store 4 can select one of the at least two parts of the reward value, and the selected part can be transmitted to the account 31 of the member (see FIG. 2).

In this embodiment, the distributed parts of the reward value comprises a first part and a second part, the first part is calculated by multiplicating a first reward ratio with the reward value, and the second part is calculated by multiplicating a second reward ratio with the reward value.

In this embodiment, the distributed parts of the reward value comprises a first part, a second part and a third part. The first part is calculated by multiplicating a first reward ratio with the reward value, the second part is calculated by multiplicating a second reward ratio with the reward value, and the third part is calculated by multiplicating a third reward ratio with the reward value.

In this embodiment, each of the first reward ratio, the second reward ratio and the third reward ratio is between 10% and 50%. Preferably, each of the first reward ratio, the second reward ratio and the third reward ratio is between 20% and 45%. More preferably, each of the first reward ratio, the second reward ratio and the third reward ratio is between 30% and 40%.

In this embodiment, the first reward ratio, the second reward ratio and the third reward ratio can be the same or different, and this disclosure is not limited.

In this embodiment, the method for distributing a reward value of this disclosure further comprises a step of: transmitting one of the parts of the reward value, which are not selected, to an account of the first store. For example, when the distributed parts comprise a first part, a second part and a third part, the member or the second store can select one of the distributed parts, and one of the unselected parts of the reward value can be transmitted to an account of the first store. In practice, the server 12 can transmit one of the parts of the reward value, which are not selected, to an account 21 of the first store (see FIG. 2).

In this embodiment, the account of the first store or the account of the member can be an electronic account, which can be, for example but not limited to, an e-bank account or an account of an electronic payment platform.

In summary, the method and system for distributing a reward value and the computer device of the system for executing the method of this disclosure can randomly distribute the reward value. Accordingly, when the customer (member) of one store purchases in other stores, the store can receive a trade reward (extra bonus) according to the method for distributing the reward value, and the member can also receive a certain ratio of trade reward by selecting a favorite reward value based on the purchasing motion. This business mechanism can provide an incentive for the member to shop in different stores, and increase the fun in shopping. Moreover, the stores will be encouraged to actively recruit members for obtaining the trade reward so as to increase their extra incomes. Accordingly, the method and system for distributing the reward value and the computer device of the system for performing the method of this disclosure can provide the trade reward to the stores for increasing the extra incomes of stores, encourage the store to recruit new members, and provide the customers to select the part of the reward value, which can provide the incentive and fun to increase the purchasing of the customers. Therefore, the trade rewards can be shared between the customer and store or between the stores.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A method for distributing a reward value, comprising steps of:
getting a consumption amount spent in a second store by a member of a first store;
calculating a reward value by multiplicating a preset ratio with the consumption amount;
randomly distributing the reward value into at least two parts of the reward value; and
transmitting one of the parts of the reward value to an account of the member.

2. The method according to claim 1, wherein the part of the reward value transmitted to the account of the member is selected by the member from the distributed parts of the reward value.

3. The method according to claim 1, wherein the part of the reward value transmitted to the account of the member is selected by the second store from the distributed parts of the reward value.

4. The method according to claim 1, wherein the distributed parts of the reward value comprises a first part and a second part, the first part is calculated by multiplicating a first reward ratio with the reward value, and the second part is calculated by multiplicating a second reward ratio with the reward value.

5. The method according to claim 1, wherein the distributed parts of the reward value comprises a first part, a second part and a third part, the first part is calculated by multiplicating a first reward ratio with the reward value, the second part is calculated by multiplicating a second reward ratio with the reward value, and the third part is calculated by multiplicating a third reward ratio with the reward value.

6. The method according to claim 1, wherein the preset ratio is between 1% and 50%.

7. The method according to claim 1, wherein the reward value is calculated by a server or a store computer device.

8. The method according to claim 7, wherein the reward value is randomly distributed into the at least two parts of the reward value by the server or the store computer device.

9. The method according to claim 1, wherein the account is an electronic account.

10. A member computer device applied to a system for distributing a reward value, wherein the system for distributing the reward value comprises the member computer device, a store computer device and a server, the member computer device and the store computer device are communicatively connected with the server, the member computer device comprises a memory unit and a processing unit, the processing unit is coupled with the memory unit, the memory unit stores a plurality of instructions, and the processing unit executes the instruction to perform a method for distributing the reward value comprising steps of:
getting a consumption amount spent in a second store by a member of a first store;
calculating a reward value by multiplicating a preset ratio with the consumption amount;
randomly distributing the reward value into at least two parts of the reward value; and
transmitting one of the parts of the reward value to an account of the member.

11. A method for distributing a reward value feeding back a first store or a member of the first store, comprising steps of:
receiving a reward value from a sponsor;
randomly distributing the reward value into at least two parts of the reward value; and
transmitting one of the parts of the reward value to an account of the member.

12. The method according to claim 11, wherein the sponsor is a physical store or a virtual store.

13. The method according to claim 12, wherein the physical store or the virtual store is a second store, and the reward value is calculated by multiplicating a preset ratio with a consumption amount, which is spent in the second store by the member of the first store.

14. The method according to claim 11, wherein the sponsor is an advertiser, a non-profit organization or an individual.

15. The method according to claim 11, wherein the part of the reward value transmitted to the account of the member is selected by the member from the distributed parts of the reward value.

16. The method according to claim 13, wherein the part of the reward value transmitted to the account of the member is selected by the second store from the distributed parts of the reward value.

17. The method according to claim 11, wherein the distributed parts of the reward value comprises a first part and a second part, the first part is calculated by multiplicating a first reward ratio with the reward value, and the second part is calculated by multiplicating a second reward ratio with the reward value.

18. The method according to claim 11, wherein the distributed parts of the reward value comprises a first part, a second part and a third part, the first part is calculated by multiplicating a first reward ratio with the reward value, the second part is calculated by multiplicating a second reward ratio with the reward value, and the third part is calculated by multiplicating a third reward ratio with the reward value.

19. The method according to claim 13, wherein the preset ratio is between 1% and 50%.

20. The method according to claim 11, wherein the account is an electronic account.
